(19) United States
(12) Patent Application Publication
(10) Pub. No.: US 2017/0178496 A1
(43) Pub. Date: Jun. 22, 2017

(54) MOTORBIKE THEFT PREVENTING DEVICE

(71) Applicant: Cha-rang Yun, Seoul (KR)

(72) Inventor: Cha-rang Yun, Seoul (KR)

(21) Appl. No.: 15/110,599

(22) PCT Filed: Jan. 7, 2015
(86) PCT No.: PCT/KR2015/000127

§ 371 Date: Sep. 29, 2016

(30) Foreign Application Priority Data
Jan. 10, 2014 (KR) 10-2014-0003266

(51) Int. Cl. G08C 21/00; B62H 5/20

(52) U.S. Cl. CPC G08C 21/00; B62H 5/20

(57) ABSTRACT

The present invention relates to a motorbike theft preventing device. The motorbike theft preventing device according to the present invention is mounted in a location where part of a current path between an input terminal and an output terminal is disconnected on the inside of a CDI unit, wherein the CDI unit is fully moulded in such a way that the whole thereof cannot be taken apart except for the input terminal and the output terminal, and wherein the inside of the CDI unit is provided with a wireless remote switch which controls whether the CDI unit is on or off by connecting in such a way that a current is made to flow between the input terminal and the output terminal of the CDI unit, which have been disconnected, if a transmission signal from a specific wireless remote control outside the CDI unit is sensed.

### CROSS-REFERENCE TO RELATED APPLICATIONS

This application is a 35 U.S.C. 371 national stage filing and claims priority to PCT Application No. PCT/KR2015/000127 entitled “MOTORBIKE THEFT PREVENTING DEVICE,” filed Jan. 7, 2015, which claims the benefit of Korean Patent Application No. 10-2014-0003266, filed Jan. 10, 2014, each of which is incorporated by reference herein in its entirety.

### TECHNICAL FIELD

The present invention relates, in general, to a motorcycle theft prevention device and, more particularly, to an absolute and faultless motorcycle theft prevention device in which no expert, other than a user, can start a motorcycle because an electric wire in a CDI unit of the motorcycle is disconnected in order to prevent the motorcycle from being stolen and because the relay of a reception unit does not connect the disconnected wire before the user transmits a signal thereto using a wireless remote controller.

### BACKGROUND ART

Generally, a motorcycle is configured such that all of the components thereof are exposed to the outside, unlike general cars. Accordingly, when a motorcycle is parked on the street or in front of a house, the motorcycle can be started merely by short-circuiting two ignition wires and pushing a start button. Therefore, the motorcycle may be easily stolen and may be defenseless against theft. In a conventional manner of preventing a motorcycle from being stolen, a product that consists of a metal chain and a lock is put on the wheel of the motorcycle or the like.

However, when such a motorcycle antitheft device is used, because it is not easy to find a place to store the metal chain, a motorcycle may not be protected from being stolen when the motorcycle is temporarily stopped or parked. In Particular, because a metal chain linked to a lock may be easily cut using a cutter or a hacksaw, use thereof is inadequate in preventing a motorcycle from being stolen.

In order to solve this problem, an alarm having an impact sensor for a motorcycle antitheft device was disclosed in Korean Patent No. 10-0996074. This technique is configured such that if the polarities of multiple first magnetic units, which are folioed in a key of a motorcycle, do not match when the key is inserted into a key hole, or if any tool, other than the key, is inserted into the keyhole, at least one switch connected with a switching terminal is maintained in an ON state, but when the release of a hand lock is attempted by forcibly turning the key, a buzzer connected with the impact sensor sounds. Also, even if no impact is applied, when a key lock is forcibly unlocked, the alarm sounds, and the ignition is not turned on.

However, this conventional patent technology is difficult to popularize because it is burdensome to a user and the installation cost is high. Also, this device merely sounds an alarm using a buzzer when it operates, but if a wire related thereto is simply disconnected, it seems outwardly as if there were nothing wrong. Accordingly, it is problematic in that a motorcycle may be forcibly started by connecting two power supply terminals, thereby failing to prevent unlocking of a hand lock and theft of the motorcycle.

Also, a smart key using RFID technology, which improves the convenience of users by operating such that the lock of a vehicle is released simply by a user carrying the smart key and such that the ignition of the vehicle is turned on by pushing a smart button, has been developed recently.

However, in the case of this convenient smart key device, an ignition may be turned on by connecting the contacts of a relay terminal upon receiving the RFID signal from a smart key. Accordingly, when someone who has no smart key forcibly opens the door of a vehicle, enters the vehicle, searches for a cable coming from the positive (+) pole of a battery, among the cables below a key box, and connects the cable to the relay terminal, current may continue to flow through the contacts of the terminal of the corresponding relay. That is, because the ignition of a vehicle may be turned on merely by enabling current to flow through the power cable from the positive (+) pole of a battery and the power cable from the negative (−) pole of a battery, the vehicle may be easily stolen.

Meanwhile, a CDI unit, which is a Capacitor Discharge Ignition device, of a motorbike serves to help an explosion stroke, among intake, compression, explosion, and exhaust strokes performed when an engine, which is a mechanism, rotates.

In other words, a CDI unit is an electric and electronic device for automatically adjusting the correct timing of the explosion depending on the RPM.

These days, a CDI unit has been superseded by an Electronic Control Unit (ECU) in the latest high-priced motorcycles or by a control box in electric motorcycles.

Consequently, it is urgently required to mount a wireless reception unit in a CDI unit, an ECU, or a control box and to control current using a remote controller or a smart remote controller in order to achieve the purpose of preventing motorcycle theft.

### DISCLOSURE

### Technical Problem

Accordingly, the present invention has been made keeping in mind the above problems occurring in the conventional art. For the past few decades, in order to prevent a motorcycle from being stolen, many people and companies have developed and manufactured alarms, smart keys, immobilizer keys, metal cables, disk locks and the like. However, when such an alarm, a smart key, or an immobilizer key is used, a motorcycle may be stolen by turning on the ignition thereof by connecting wires, or a motorcycle, stolen by loading the entire body thereof into a truck or the like, may be repaired by an expert and may then be ridden or sold. Alternatively, when a metal cable, a front fork fitted with locking device, a disk lock, or the like is used, a motorcycle may be stolen by cutting such an item or by loading the entire body of the motorcycle into a truck or the like. Therefore, an object of the present invention is to provide a motorcycle theft prevention device for completely preventing the motorcycle from being stolen.

Motorcycle theft is committed with the aim of riding or selling a motorcycle. Because the theft may be prevented if these two aims cannot be achieved, the present invention intends to make an expert, other than the owner of a motorcycle, unable to start and ride the motorcycle. Also, in the present invention, even if a professional thief steals a motorcycle by loading the entire body thereof into a truck or the like, the CDI unit must be designed and manufactured to be adapted to an engine, but because only a law-abiding specialist may undertake such a design and manufacturing process, and because even if it were possible to perform such design and manufacturing processes, it would be very expensive, a thief is dissuaded from even considering stealing the motorcycle.

### Technical Solution

In order to accomplish the above objects, a motorcycle theft prevention device according to the present invention is configured such that all parts thereof, excluding an input terminal and an output terminal, are embedded in a CDI unit, which is completely molded in order to prevent the parts embedded therein from being disassembled, and a part of a current path between the input terminal and the output terminal is disconnected in the CDI unit and a wireless remote switch unit is installed in the disconnected part of the current path in the CDI unit, wherein the wireless remote switch unit controls on/off operation of the CDI unit by enabling current to flow between the input terminal and the output terminal by connecting the disconnected part therebetween when a signal transmitted from a specific wireless remote controller outside the CDI unit is detected.

Also, it is desirable for the wireless remote switch unit to include a wireless reception unit for receiving a wireless signal, a relay switch for opening or closing the current path in the CDI unit, and a control unit, connected with the wireless reception unit and the relay switch, for operating the relay switch when a specific signal is detected by the wireless reception unit.

Also, the wireless remote controller and the wireless remote switch unit may be configured such that the wireless remote switch unit is automatically turned on when the wireless remote controller is closer to the wireless remote switch unit than a certain distance, and that the wireless remote switch unit is automatically turned off when the wireless remote controller is farther apart from the wireless remote switch unit than the certain distance.

### Advantageous Effects

As described above, according to the motorcycle theft prevention device of the present invention, because no expert may start a motorcycle even if the motorcycle is completely disassembled after removing the skirt thereof, and because thieves may never achieve their purposes, thieves do not even try to steal motorcycles.

Globally, many motorcycles are stolen, and the stolen motorcycles are used to commit other crimes such as purse-snatching and the like. However, if motorcycle theft can be fundamentally prevented by the present invention, social problems from these crimes may be reduced.

### DESCRIPTION OF DRAWINGS

FIG. 1 is a perspective view illustrating a motorcycle theft prevention device according to the present invention;

FIG. 2 is a block diagram illustrating a motorcycle theft prevention device according to the present invention; and

FIG. 3 is a block diagram of a wireless remote switch unit of a motorcycle theft prevention device according to the present invention.

### DESCRIPTION OF THE REFERENCE NUMERALS IN THE DRAWINGS

10: CDI unit

11: input terminal

12: output terminal

20: wireless remote switch unit

21: wireless reception unit

22: control unit

23: relay switch

30: wireless remote controller

### BEST MODE

Hereinafter, a specific embodiment of the present invention will be described in detail with reference to the accompanying drawings.

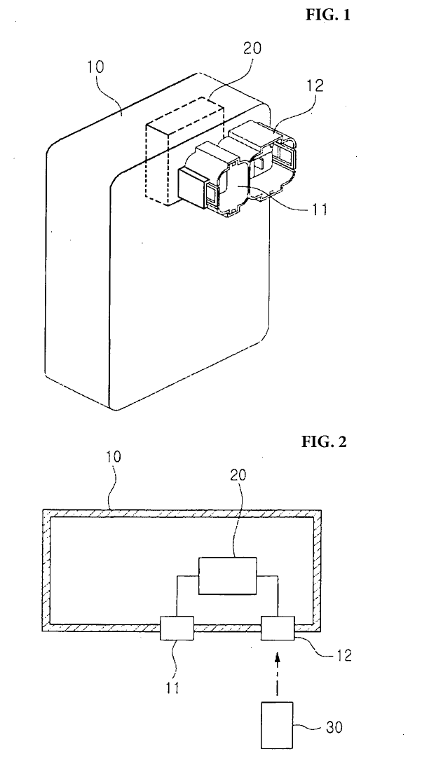

FIG. 1 is a perspective view illustrating a motorcycle theft prevention device according to the present invention.

The motorcycle theft prevention device according to the present invention is configured such that only an input terminal 11 and an output terminal 12 are exposed outside and the other components are embedded in a CDI unit 10, which is completely molded in order to prevent the components therein from being disassembled, as illustrated in FIG. 1.

The CDI unit 10 is a component that serves to receive pulsed current (weak current) and excited current (strong current) from an engine and a generator and to make a suitable voltage by stepping up the weak current or stepping down the strong current. Because the CDI unit is an important component at the heart of a motorcycle, it is completely molded, so that no expert can dismantle it. Therefore, when the CDI unit 10 is initially designed and manufactured, it may be configured such that a wireless reception unit 21 is embedded therein and the owner of a motorcycle controls the current through remote control, or such that a smart key chip is embedded therein and when the owner of the motorcycle is closer than a certain distance, a wireless remote switch unit 20 automatically operates so as to connect a power supply to a relay switch 23, whereby an ignition is turned on, but when the owner of the motorcycle is farther from the motorcycle than the certain distance, the supply of power inside the CDI unit 10 is automatically interrupted.

Accordingly, no expert, other than the owner of the motorbike, can start the motorcycle. Also, because a motorcycle is small in volume, a thief may steal the motorcycle by loading the entire body thereof into a truck or the like. However, even if the motorcycle is stolen in this way, the thief cannot ride or sell it because the CDI unit 10 thereof is inoperable. Therefore, absolute and faultless theft prevention may be realized.

A thief who has stolen a motorcycle typically intends to ride it or make money by selling it. However, if the CDI unit 10 of the stolen motorcycle does not operate, it is not possible to ride it because the ignition cannot be turned on, and the engine becomes useless and thus no one will buy the motorcycle. Because, in order to turn on the ignition of the stolen motorcycle, the CDI unit 10 thereof must be redesigned and newly manufactured, but the expense therefor amounts to hundreds of millions of KRW. In other words, even if a thief steals the motorcycle, the thief cannot achieve his or her objective. Therefore, even if the owner of the motorcycle parks the motorcycle anywhere for several days, it is free from the risk of being stolen. This is because the theft prevention device, which precludes a thief from riding or selling a motorcycle, is installed in the motorcycle.

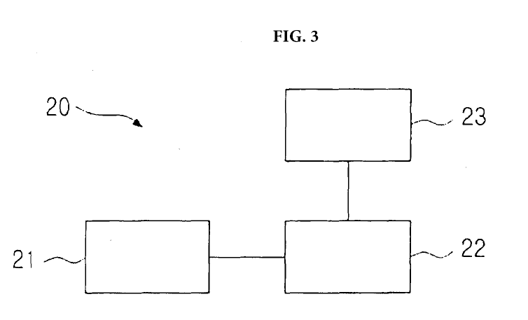

FIG. 2 and FIG. 3 show a block diagram illustrating a motorcycle theft prevention device according to the present invention, and the motorcycle theft prevention device according to the present invention is configured such that a wireless remote switch unit 20, which includes a wireless reception unit 21, a control unit 22 and a relay switch 23, is additionally installed inside a conventional CDI unit 10, which cannot be dismantled because it is completely molded, and the installed wireless remote switch unit is controlled using a wireless remote controller 30 from the outside.

In the CDI unit 10, a part of a current path, which connects the input terminal 11 and the output terminal 12 of the CDI unit, is disconnected, and the wireless remote switch unit 20 is installed in the disconnected part of the current path. Accordingly, when the relay switch 23 of the wireless remote switch unit 20 is turned on, the CDI unit 10 may operate, whereby it is possible to turn on an ignition. Conversely, when the relay switch 23 is turned off, the CDI unit 10 may not operate, whereby it is impossible to turn on the ignition.

Because the relay switch 23 is electrically connected to the control unit 22, which is electrically connected to the wireless reception unit 21, the relay switch 23 is turned on or off depending on the signal transmitted from the control unit 22. The circuit of the wireless remote switch unit 20 is configured such that the relay switch 23 is automatically turned off when the ignition of a motorcycle is turned off.

The wireless reception unit 21, connected to the control unit 22, responds only to a specific frequency transmitted from the wireless remote controller 30, which is carried by the owner of the motorcycle, and thereby makes the control unit 22 turn on the relay switch 23.

Because the configuration of the wireless remote switch unit 20, the operation of which is switched in response to reception of a wireless signal, has been widely known, a detailed description thereabout will be omitted.

As described above, if the wireless remote controller 30 is a high-end one, it may be configured as a smart key, which automatically operates when it is closer to the motorcycle than a certain distance, but if it is not a high-end one, it may be configured to be separate from a key and to operate when a switch button is pushed.

Because the power supply of the wireless reception unit 21 uses a conventional 12V battery of a motorcycle, when the battery is switched on using the key of a motorcycle, the wireless reception unit 21 operates, and may receive signals from the wireless remote controller 30. In other words, in the state in which the battery is switched on, the wireless remote switch unit 20 is switched to an ON state by pushing the wireless remote controller 30, and then when the start button of the motorcycle is pushed, the ignition of the motorcycle is turned on.

Meanwhile, the CDI unit of a motorcycle is a Capacitor Discharge Ignition device and an electric and electronic device for adjusting the correct timing of an explosion depending on the RPM.

However, these days, the CDI unit has been superseded by an ECU in the case of expensive motorcycles, or by a control box in the case of electric motorcycles.

In other words, the ECU or the control box has a different name from the CDI unit, but the role thereof is the same as the role of the CDI unit, and the embodiment of the device for preventing the motorcycle, in which an ECU or a control box is installed, from being stolen is as follows.

A motorcycle theft prevention device according to another embodiment of the present invention is configured such that all of the components, excluding an input terminal and an output terminal, are contained in an ECU or a control box, which is completely molded, and a part of a current path between the input terminal and the output terminal is disconnected and a wireless remote switch unit is installed in the disconnected part of the current path inside the ECU or the control box. Accordingly, when a signal transmitted from a specific wireless remote controller outside the ECU or the control box is detected, the wireless remote switch unit enables current to flow between the input terminal and the output terminal by connecting the disconnected part therebetween, thereby controlling the on/off operation of the ECU or the control box.

Also, the wireless remote switch unit is characterized in that it is automatically turned on when the wireless remote controller is closer thereto than a certain distance, but it is automatically turned off when the wireless remote controller is farther apart therefrom than the certain distance.

Particularly, in the configuration of the CDI unit, the ECU, or the control box, the input and output terminals, which are connected to a plug for enabling current to be input to or output from the CDI unit, the ECU, or the control box, may be placed in a plastic mold or a steel mold.

In this case, the wireless remote switch unit, which includes a wireless reception unit for receiving wireless signals, a relay switch for opening or closing the current path inside the CDI unit, the ECU, or the control box, and a control unit, connected with the wireless reception unit and the relay switch, for operating the relay switch when a specific signal is detected by the wireless reception unit, is further included in the mold.

Also, the wireless remote switch unit is characterized in that it is automatically turned on when the wireless remote controller is closer thereto than a certain distance, but it is automatically turned off when the wireless remote controller is apart therefrom than the certain distance.

As described above, although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A motorcycle theft prevention device, in which
all parts thereof, excluding an input terminal and an output terminal, are embedded in a CDI unit, which is completely molded in order to prevent the parts embedded therein from being disassembled, and a part of a current path between the input terminal and the output terminal is disconnected in the CDI unit and a wireless remote switch unit is installed in the disconnected part of the current path in the CDI unit,
wherein the wireless remote switch unit controls on/off operation of the CDI unit by enabling current to flow between the input terminal and the output terminal by connecting the disconnected part therebetween when a signal transmitted from a specific wireless remote controller outside the CDI unit is detected.

2. The motorcycle theft prevention device of claim 1, wherein the wireless remote switch unit comprises:
a wireless reception unit for receiving a wireless signal;
a relay switch for opening or closing the current path in the CDI unit; and
a control unit, connected with the wireless reception unit and the relay switch, for operating the relay switch when a specific signal is detected by the wireless reception unit.

3. The motorcycle theft prevention device of claim 1, wherein the wireless remote controller and the wireless remote switch unit are configured such that
the wireless remote switch unit is automatically turned on when the wireless remote controller is closer to the wireless remote switch unit than a certain distance, and
the wireless remote switch unit is automatically turned off when the wireless remote controller is farther apart from the wireless remote switch unit than the certain distance.

4. A motorcycle theft prevention device, in which
all parts thereof, excluding an input terminal and an output terminal, are embedded in an ECU or a control box, which is completely molded, and a part of a current path between the input terminal and the output terminal is disconnected in the ECU or the control box and a wireless remote switch unit is installed in the disconnected part of the current path in the ECU or the control box,
wherein the wireless remote switch unit controls on/off operation of the ECU or the control box by enabling current to flow between the input terminal and the output terminal by connecting the disconnected part therebetween when a signal transmitted from a specific wireless remote controller outside the ECU or the control box is detected.

5. The motorcycle theft prevention device of claim 4, wherein the wireless remote switch unit is configured to:
be automatically turned on when the wireless remote controller is closer thereto than a certain distance; and
be automatically turned off when the wireless remote controller is farther apart therefrom than the certain distance.

6. The motorcycle theft prevention device of claim 4, wherein input and output terminals connected to a plug for enabling current to be input to or output from the CDI unit, the ECU, or the control box are placed in a steel mold and a plastic mold.

7. The motorcycle theft prevention device of claim 6, wherein the wireless remote switch unit is further included in the mold,
the wireless remote switch unit including:
a wireless reception unit for receiving a wireless signal;
a relay switch for opening or closing the current path inside the CDI unit, the ECU, or the control box; and
a control unit, connected with the wireless reception unit and the relay switch, for operating the relay switch when a specific signal is detected by the wireless reception unit.

8. The motorcycle theft prevention device of claim 7, wherein the wireless remote switch unit is configured to:
be automatically turned on when the wireless remote controller is closer thereto than a certain distance; and
be automatically turned off when the wireless remote controller is farther apart therefrom than the certain distance.

9. The motorcycle theft prevention device of claim 2, wherein the wireless remote controller and the wireless remote switch unit are configured such that
the wireless remote switch unit is automatically turned on when the wireless remote controller is closer to the wireless remote switch unit than a certain distance, and
the wireless remote switch unit is automatically turned off when the wireless remote controller is farther apart from the wireless remote switch unit than the certain distance.

10. The motorcycle theft prevention device of claim 1, wherein input and output terminals connected to a plug for enabling current to be input to or output from the CDI unit, the ECU, or the control box are placed in a steel mold and a plastic mold.
